(19) United States
(12) Patent Application Publication
(10) Pub. No.: US 2005/0231978 A1
(43) Pub. Date: Oct. 20, 2005

(54) High efficiency low power LED backlighting system for liquid crystal display

(76) Inventors: Anthony Mark Kvenvold, Harvard, MA (US); Brad Harkavy, Cambridge, MA (US)

Correspondence Address: BURNS & LEVINSON LLP, 1030 15TH STREET NW, SUITE 300, WASHINGTON, DC, 20005-1501, US

(21) Appl. No.: 11/085,677

(22) Filed: Mar. 21, 2005

Related U.S. Application Data
(60) Provisional application No. 60/555,724, filed on Mar. 23, 2004.

(51) Int. Cl. G02F 1/1335

(52) U.S. Cl. 362/600

(57) ABSTRACT

A backlighting system for liquid crystal display provides low power consumption and high efficiency. The backlighting system includes an array of LEDs arranged in a matrix to generate backlight needed to display light and dark colors on the liquid crystal display. The backlighting system emulates light and dark areas of video images being displayed on the liquid crystal display, selectively backlighting only areas of the liquid crystal display that require backlighting, thereby reducing power consumption.

### PRIORITY

This application relates to and claims priority under 35 U.S.C 109(e) from U.S. Provisional Application Ser. No. 60/555,724, filed Mar. 23, 2004, entitled “Low Power LED Backlight For LCD Displays”, which is hereby incorporated by reference in its entirety.

### FIELD OF THE INVENTION

The present invention relates generally to backlighting of liquid crystal display (LCD) video panels with light emitting diodes (LEDs), and more particularly a system that electronically allows for individual power control of each LED to adapt to changing light levels needed to display light and dark colors on a liquid crystal display.

### BACKGROUND OF THE INVENTION

Flat liquid crystal display monitors are in wide use in televisions, computer monitors and handheld electronics. The backlights built into these devices for the most part provide a light intensity that is adequate for the indoor use. In addition adequate power is available for liquid crystal display units that remain in a fixed location.

These liquid crystal display units now required higher resolution and greater viewing angles to satisfy the market. To do this the transmission of light from the backlight needs to be increased due to the lowered transmisivity of light through the liquid crystal display. In addition liquid crystal display devices are used more and more in outdoor and high sunlight conditions. This requires the use of brighter and more powerful backlights. Backlight power usage in mobile, portable, and to a lesser extent stationary liquid crystal display units now becomes problematic. As the power needed to backlight a liquid crystal display is increased more heat is produced by the various lighting systems, causing added problems.

The typical backlights used in liquid crystal display are fluorescent lamps. These lamps are powered by a high voltage power supply known as an inverter. The inverter power supply typically drives all the tubes in a backlight and is expensive to purchase. Fluorescent lamps are made of glass tubing, which makes them inherently fragile if exposed to environmental stresses. Fluorescent tubes are presently used in sunlight conditions to high bright a liquid crystal display, but this requires a large number of tubes, more or larger inverter power supplies, that consume 20 to 70 watts of power to high-bright depending the illumination needed.

LED backlighting systems have recently been applied to liquid crystal display applications with some advantages over fluorescent tubes. The power supply for a LED backlighting system is normally a low voltage supply and a plastic housing of a solid state device makes it well suited for extreme conditions. However, the typical LED backlight will require about 20 to 70 watts of power to high-bright a display.

It is therefore desirable to provide a backlighting system for liquid crystal displays that provides high efficiency in power consumption.

### SUMMARY OF THE INVENTION

The present invention relates to a backlighting system for liquid crystal display that allows low power consumption, the liquid crystal display having an array of LEDs arranged in a matrix to generate backlight as needed to display light and dark colors on the liquid crystal display.

According to one aspect of the invention, a backlighting system for liquid crystal display is provided having an array of LED's arranged in a matrix to generate a backlight for a liquid crystal display, a solid state circuit unit to control individually each LED in the array, an interconnect means for power and to communicate instructions to the solid state circuit, a processing circuit to convert video display information into light intensity information and communicate said converted information to the programmed solid state circuits, a power supply means to power the light emitting assembly. The backlighting system emulates light and dark areas of the image being displayed on the liquid crystal display, selectively backlighting only areas of the liquid crystal display that require backlighting, thereby reducing power consumption.

### BRIEF DESCRIPTION OF THE DRAWINGS

FIG. 1 is a schematic front view showing a liquid crystal display with a matrix of LEDS according to the invention.

FIG. 2 is a schematic sectional view showing the back of a printed circuit board of the liquid crystal display according to the invention.

FIG. 3 is a block diagram showing the process of backlighting a liquid crystal display according to the invention.

### DESCRIPTION OF THE PREFERRED EMBODIMENT

A backlighting assembly for liquid crystal display according to the invention includes an array of LEDs arranged in a matrix, a pre-programmed solid state circuit unit to control each individual LED in the array, an inter-connecter for carrying power and for communicating instructions to the pre-programmed solid state circuit, a processing circuit for converting video display information into light intensity information and then communicate the converted information to the pre-programmed solid state circuits, and a power supply to power the backlighting assembly.

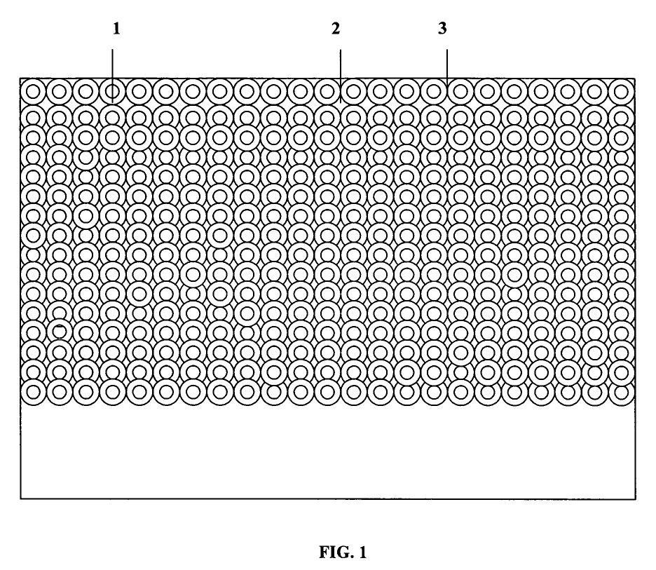

FIG. 1 illustrates a backlighting assembly for liquid crystal display. The backlighting assembly includes a matrix of LED's 1, mounted on a printed circuit board 3, with an optional lens 2. The lens 2 is typically made from clear plastic. The lens 2 could be molded and placed over the top of the LED's 1, or when desired be incorporated into the LED packaging. The LED's 1 could be selected from one of the several commercially available packaged types and be mounted to the printed circuit board 3 so that heat produced is channeled to a copper layer used as a heat sink.

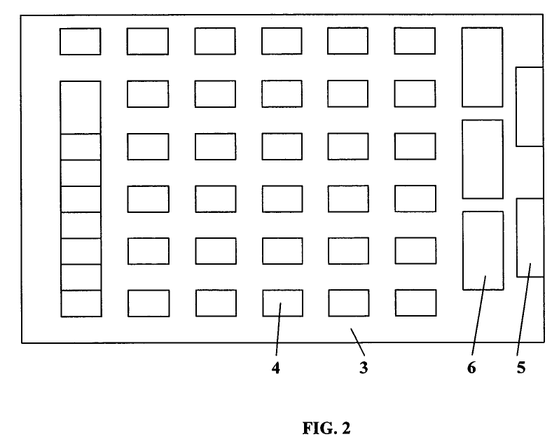

FIG. 2 illustrates the back of the printed circuit board 3 that is typically populated by the electronics used to drive or power the LED's 1 and all functions needed to run the backlight. The microcircuit 4 includes a masked device specifically made to perform the functions of decoding a signal and controlling any number of LED's 1 or it may be a commercially available microcontroller that has been programmed to perform the functions of decoding a signal and controlling a number of LED's 1. The number of microcircuits 4 would correspond to the number of LED's 1 controlled by it and the number of LED's 1 needed for the size and makeup of the display it would backlight. The microcircuit 4 powers the LED's 1 with a pulse width modulated signal (PWM). The PWM power signal is adjusted to attain the illumination as is needed by an individual LED 1 in order to remain in sync with the pixels of the liquid crystal display.

Power consumed by the backlighting system is saved by lighting only the LEDs that are needed and then only to the intensity needed to properly operate the liquid crystal display in the ambient lighting conditions it is exposed to at any one time. For example, the power is saved by the individual control LEDs in sync with a liquid crystal display, such that a black area of the liquid crystal display would result in the corresponding LED remaining off and a dark color area of the liquid crystal display would result in about 60% on time in the corresponding LED and a white area of the liquid crystal display would result in a full illumination of the corresponding LED.

The backlight can control power performance of the backlight in a variety of ways. The average power or peak power can be limited to ensure that the temperature, current, battery life limits are met. The heat produced by the illumination of the LED's is reduced with the individual illumination of the LED's in sync with the video being displayed by the liquid crystal display.

The microprocessors 6 needed to split the video signal, encode the video signals, and send a communications to the microcircuits are commercially available. The microprocessors 6 are programmed to perform the functions as described. Connectors 5 are used to provide power as well as input the video signal and output the split video signal to the LCD. The components mounted on the printed circuit board are interconnected by the copper trace layout of the printed circuit board 3.

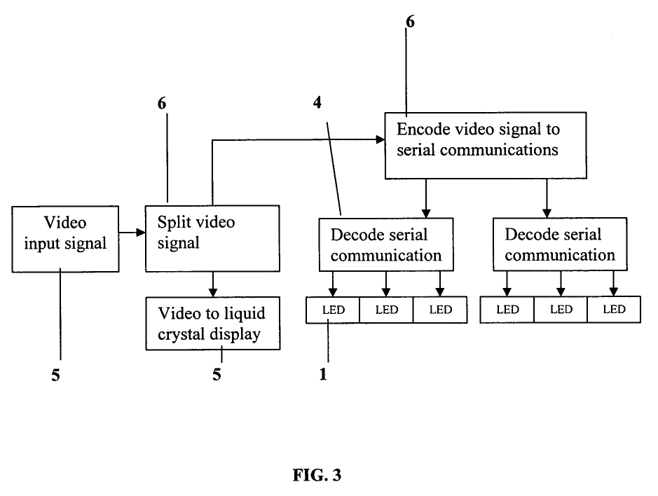

FIG. 3 illustrates a schematic in block form. The number of LED's 1 used on a typical design would be variable as would the number of microcircuits 4. The outputs from the microcircuits 4 and microprocessors 6 would not be limited to specific number.

According to one embodiment of the invention, a backlighting system is used with a conventional liquid crystal display. This embodiment uses circuitry to control an array of white or colored LED's to individually vary the intensity of each area of the liquid crystal display as it corresponds to the video image displayed on the liquid crystal display and powered by DC power supply. The backlighting system includes at least one input/output register for receiving video display information and splitting the video display information into two matching video display signals, i.e. a first video display signal and a second video display signal. For example, the backlight receives a video signal that is derived from the same video signal going to the LCD to ensure that both signals are in sync with each other. This is accomplished by circuitry that receives a standard video input, such as VGA or LVDS, then converts said video signal into serial communication data to be sent to the LED backlight array while the standard video signal is passed onto the LCD. The serial communication data is then sent over a communications bus to a multitude of pre-programmed microcircuits capable of decoding the serial communication data into information that will power a multitude of LED's with a pulsing signal of variable width (PWM-pulse width modulation) as decoded by the microcircuit from its serial communication data. The LED will then illuminate to an appropriate brightness in sync with the LCD picture being produced. The LED placed behind its corresponding area, on the LCD will be illuminated as may be needed so that a black area will have no illumination and a white area would require full illumination, therefore conserving the amount of power consumed by the backlight. Areas of the image that are neither black nor white will be illuminated to the grayscale value corresponding to the average pixel values of the corresponding section of the LCD panel being illuminated.

According to another embodiment of the invention, a backlighting system is provided that operates independently of the standard video input signal but yet operate the LED's in sync with each other. This will be accomplished by circuitry that receives a standard video input, such as VGA or LVDS, then converts said video signal into serial communication data to be sent to the LED backlight array. The serial communication data is then sent over a communications bus to a multitude of pre-programmed microcircuits capable of decoding the serial communication data into information that will power a multitude of LED's with a pulsing signal of variable width (PWM-pulse width modulation) as decoded by the microcircuit from its serial communication data. The LED will then illuminate to an appropriate brightness in sync with the LCD picture being produced. The LED placed behind its corresponding area, on the LCD will be illuminated as may be needed so that a black area will have no illumination and a white area would require full illumination, therefore conserving the amount of power consumed by the backlight.

According to yet another embodiment of the invention, a backlighting system for a liquid crystal display is provided that operates independently of the standard video input signal but yet operates the LED's in sync with each other. This is accomplished by circuitry that receives a standard video input, such as VGA or LVDS, then converts said video signal into addressable communication data to be sent to the LED backlight array. The addressable communication data is then sent over a communications bus to a multitude of pre-programmed microcircuits capable of decoding the addressable communication data into information that will power a multitude of LED's with a pulsing signal of variable width (PWM-pulse width modulation) as decoded by the microcircuit from its addressable communication data. The LED will then illuminate to an appropriate brightness in sync with the LCD picture being produced. The LED placed behind its corresponding area, on the LCD will be illuminated as may be needed so that a black area will have no illumination and a white area would require full illumination, therefore conserving the amount of power consumed by the backlight.

According to another embodiment of the invention, a backlighting system for a liquid crystal display is provided that operates independently of the standard video input signal but yet operates the LED's in sync with each other. This is accomplished by circuitry that receives a standard video input, such as VGA or LVDS, then converts said video signal into addressable communication data to be sent to the LED backlight array. The addressable communication data is then sent over a communications bus to a multitude of programmable microcircuits capable of decoding the addressable communication data into information that will power a multitude of LED's with a pulsing signal of variable width (PWM-pulse width modulation) as decoded by the microcircuit from its addressable communication data. When desired, the programming of the programmable microcircuits can be changed to achieve the specific requirements of the backlighting system. The LED will then illuminate to an appropriate brightness in sync with the LCD picture being produced. The LED placed behind its corresponding area, on the LCD will be illuminated as may be needed so that a black area will have no illumination and a white area would require full illumination, therefore conserving the amount of power consumed by the backlight.

According to another embodiment of the invention, a backlighting system for a liquid crystal display is provided that operates independently of the standard video input signal but yet operates the LED's in sync with each other. This is accomplished by circuitry that receives a standard video input, such as VGA or LVDS, then converts said video signal into addressable communication data to be sent to the LED backlight array. The addressable communication data is then sent over a communications bus to a programmable microcircuit capable of decoding the addressable communication data into information that will power a multitude of LED's on and off as decoded by the microcircuit from its addressable communication data. The LED will then illuminate to an appropriate brightness in sync with the LCD picture being produced. The LED placed behind its corresponding area, on the LCD will be illuminated as may be needed so that a black area will have no illumination and a white area would require full illumination, therefore conserving the amount of power consumed by the backlight.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A backlighting system for a liquid crystal display showing video images, the backlighting system comprising:
an array of LEDs arranged in a matrix to generate backlight for the liquid crystal display;
a solid state circuit unit to control individually each LED in the array;
an interconnect means for carrying power and for communicating information to the solid state circuit;
a control means for receiving a video display information, converting the video display information into light intensity information, and communicating the light intensity information to the solid state circuits; and
a power supply to power the backlighting system.

2. The backlighting system according to claim 1, wherein the solid state circuit is a pre-programmed solid state circuit.

3. The backlighting system according to claim 1, wherein the solid state circuit is a programmable solid state circuit.

4. The backlighting system according to claim 1, wherein the control means comprises at least one input/output register for receiving video display information and splitting the video display information into two matching video display signals, a first video display signal and a second video display signal.

5. The backlighting system according to claim 4, wherein the first video display signal is communicated to the liquid crystal display.

6. The backlighting system according to claim 4, wherein the control means further comprising a microcontroller for encoding the second video display signal into a communication signal.

7. The backlighting system according to claim 4, wherein the control means further comprising a plurality of microcontrollers for decoding the communication signal and communicating the communication signal to the solid state circuits to individually control the illumination level of each LED in the array.

8. The backlighting system according to claim 7, wherein the illumination level of each LED in the array of the LED matrix is in sync with the video image being displayed on the liquid crystal display.

9. The backlighting system according to claim 8, wherein power consumed by the backlighting system is reduced by the individual illumination of each LED in the array in sync with the video image being displayed by the liquid crystal display.

10. The backlighting system according to claim 8, wherein heat produced by the illumination of the LED matrix is reduced by the individual illumination of each LED in the array in sync with the video being displayed by the LCD.

11. The backlighting system according to claim 4, wherein the communication signal is in a form of addressable communication data.

12. The backlighting system according to claim 4, wherein the communication signal is in a form of serial communication data.
